(19) United States
(12) Patent Application Publication
(10) Pub. No.: US 2021/0253066 A1
(43) Pub. Date: Aug. 19, 2021

(54) VEHICLE WASHING DEVICE

(71) Applicant: DENSO CORPORATION, Kariya-city, Aichi (JP)

(72) Inventors: Daisuke SHIRAKURA, Kariya-city (JP); Masaaki KIYAMA, Kariya-city (JP); Shouta ADACHI, Kariya-city (JP)

(73) Assignee: DENSO CORPORATION, Kariya-city, Aichi (JP)

(21) Appl. No.: 17/251,457

(22) PCT Filed: Mar. 13, 2019
(86) PCT No.: PCT/JP2019/010287

§ 371 Date: Dec. 11, 2020

(30) Foreign Application Priority Data
Jun. 12, 2018 (JP) 2018-111978

(51) Int. Cl. B60S 1/48; B60S 1/58

(52) U.S. Cl. CPC B60S 1/485; B60S 1/583

(57) ABSTRACT

A vehicle washing device, including: a wiping section configured to wipe a predetermined range on a windshield of a vehicle, the predetermined range including an imaging range of an imaging section configured to image an exterior of the vehicle through the windshield from inside a vehicle cabin; and a spraying section provided outside the vehicle cabin and configured to spray a washer liquid onto the windshield, the spraying section having a spray direction of the washer liquid configured such that a spray region of the washer liquid interposed between a pair of tangents, each extending from the spraying section and tangential to a landing region at which the sprayed washer liquid lands on the windshield, has an overlap with the imaging range of no greater than a predetermined proportion of the imaging range, or such that the spray region is separated from a predetermined region of the imaging range.

### TECHNICAL FIELD

The present invention relates to a vehicle washing device.

### BACKGROUND ART

Japanese Patent Application Laid-Open (JP-A) No. 2005-319983 discloses an example of technology in which a CCD camera attached to a vehicle cabin side of a rear glass images outside the vehicle through the rear glass for display on a driver seat monitor screen. A wiper device is attached to an upper portion of the rear glass to wipe the rear glass in front of the CCD camera.

### SUMMARY OF INVENTION

### Technical Problem

In order to adequately wash a rear windshield in a case in which the surface of the rear windshield is dry, for example, it is preferable to spray washer liquid onto the rear windshield from a nozzle of a rear washer so as to lubricate the rear windshield before wiping the rear windshield with a wiper. However, in a case in which an imaging section is provided to image the vehicle outside through the rear windshield, if washer liquid adheres to the rear windshield in an imaging range of the imaging section or a jet of washer liquid cuts across the imaging range, this may appear as distortion in images captured by the imaging section.

In particular, when images captured by such an imaging section are employed as what is referred to as an electronic interior mirror in which the images are displayed on a monitor screen display section for an occupant to look at in order to check the situation outside the vehicle, an undesirable situation may arise in which it becomes difficult for the occupant to check the situation outside the vehicle when such distortion is present in the images.

In consideration of the above circumstances, an object of the present invention is to obtain a vehicle washing device capable of suppressing distortion from appearing in an image captured through a windshield by an imaging section when washer liquid is sprayed in order to wash the windshield.

### Solution to Problem

A vehicle washing device according to a first aspect of the present disclosure includes a wiping section configured to wipe a predetermined range on a windshield of a vehicle, the predetermined range including an imaging range of an imaging section configured to image an exterior of the vehicle through the windshield from inside a vehicle cabin, and a spraying section provided an exterior of the vehicle cabin and configured to spray a washer liquid onto the windshield. The spraying section has a spray direction of the washer liquid configured such that a spray region of the washer liquid interposed between a pair of tangents each extending from the spraying section and tangential to a landing region at which the sprayed washer liquid lands on the windshield has an overlap with the imaging range of no greater than a predetermined proportion of the imaging range, or such that the spray region is separated from a predetermined region of the imaging range.

In the first aspect of the present disclosure, the wiping section wipes the predetermined range, including the imaging range on the windshield of the imaging section that images the vehicle outside through the windshield of the vehicle from inside the vehicle cabin. The spraying section sprays washer liquid onto the windshield. Note that the spray direction of the washer liquid from the spraying section is set such that the washer liquid spray region interposed between the pair of tangents each extending from the spraying section and tangential to the landing region where the sprayed washer liquid lands on the windshield has an overlap with the imaging range of no greater than the predetermined proportion of the imaging range, or such that the spray region is at a separation from the predetermined region of the imaging range.

Thus, when spraying the washer liquid in order to wash the windshield including the imaging range of the imaging section, a portion of captured images where distortion might appear accompanying this spraying of washer liquid is suppressed to no greater than the predetermined proportion of the imaging range of the imaging section, or to a region excluding the predetermined region of the imaging range. Such a configuration is thereby capable of suppressing distortion from appearing in images captured through the windshield by the imaging section when spraying the washer liquid in order to wash the windshield.

A second aspect of the present disclosure is the first aspect of the present disclosure, wherein the predetermined region is a region excluding regions at respective ends of the imaging range in a width direction of the vehicle when the imaging range is divided into five equal segments in the width direction.

The second aspect of the present disclosure suppresses the washer liquid from being sprayed in and around a vehicle width direction central portion of the imaging range, this being an important region thereof. This thereby enables the impact on images captured by the imaging section to be suppressed to a low level, even if the washer liquid spray region and the imaging range overlap each other.

A third aspect of the present disclosure is the second aspect of the present disclosure, wherein the predetermined region is a region excluding a lower end region when the imaging range is divided into five equal segments in a vertical direction of the vehicle.

The lower end region of the imaging range corresponds to a region of lower importance in a captured images, and the impact is low even if washer liquid drips downward from this region. The third aspect of the present disclosure thereby enables the impact on images captured by the imaging section to be suppressed to an even lower level, even if the washer liquid spray region and the imaging range overlap each other.

A fourth aspect of the present disclosure is any one of the first aspect to the third aspect of the present disclosure, wherein the wiping section wipes the predetermined range by moving a wiper blade to and fro. In the spraying section the washer liquid spray direction is configured such that at least a portion of the landing region of the washer liquid overlaps with a movement range on the windshield of a portion of the wiper blade that wipes the imaging range.

In the fourth aspect of the present disclosure, the washer liquid spray direction of the spraying section is set such that at least a portion of the landing region of the washer liquid sprayed from the spraying section and landing on the windshield overlaps with the movement range on the windshield of the portion of the wiper blade that wipes the imaging range on the windshield. Thus, the washer liquid sprayed from the spraying section is reliably supplied to the portion of the wiper blade that wipes the imaging range, enabling the imaging range of the imaging section to be effectively washed accompanying spraying of the washer liquid from the spraying section and the to and fro movement of the wiper blade of the wiping section.

A fifth aspect of the present disclosure is any one of the first aspect to the fourth aspect of the present disclosure, the wiping section wipes the predetermined range by moving a wiper blade to and fro. In the spraying section the washer liquid spray direction is configured such that a movement trajectory of one end portion of the wiper blade on the windshield cuts across the washer liquid spray region and a movement trajectory of another end portion of the wiper blade on the windshield cuts across the washer liquid spray region.

In the fifth aspect of the present disclosure, the washer liquid spray direction of the spraying section is set such that the movement trajectory of the one end portion of the wiper blade on the windshield cuts across the washer liquid spray region and the movement trajectory of the other end portion of the wiper blade on the windshield cuts across the washer liquid spray region. This enables the washer liquid sprayed from the spraying section to be spread across the entire length of the wiper blade, thereby enabling the predetermined range including the imaging range of the imaging section to be effectively washed accompanying spraying of the washer liquid from the spraying section and the to and fro movement of the wiper blade of the wiping section.

A sixth aspect of the present disclosure is any one of the first aspect to the fifth aspect of the present disclosure, wherein in the spraying section the washer liquid spray direction is set such that any overlap between the washer liquid spray region and the imaging range is no greater than 20% of the imaging range. This enables a portion of captured images where distortion might appear accompanying spraying of washer liquid from the spraying section to be suppressed to no greater than 20% of the imaging range of the imaging section.

A seventh aspect of the present disclosure is any one of the first aspect to the sixth aspect of the present disclosure, wherein the wiping section wipes the predetermined range by moving a wiper blade to and fro. The vehicle washing device further includes a first control section configured to cause the washer liquid to be sprayed from the spraying section in a state in which the spray region and the imaging range are positioned in this sequence on a movement direction downstream side during an outward movement or during a return movement of the wiper blade, and the wiper blade has approached to within a predetermined distance of the spray region. Thus, the imaging range of the imaging section is wiped within a short time of the washer liquid being supplied to the wiper blade, enabling the imaging range of the imaging section to be effectively washed.

An eighth aspect of the present disclosure is any one of the first aspect to the seventh aspect of the present disclosure, the wiping section wipes the predetermined range by moving a wiper blade to and fro. The vehicle washing device further includes a second control section configured to control a movement speed of the wiper blade as the wiper blade wipes the imaging range when the washer liquid is being sprayed from the spraying section so as to be slower than a movement speed of the wiper blade when the washer liquid is not being sprayed from the spraying section. Wiping the imaging range of the imaging section at a lower wiping speed when the washer liquid is being sprayed from the spraying section enables the imaging range of the imaging section to be effectively washed.

A ninth aspect of the present disclosure is any one of the first aspect to the eighth aspect of the present disclosure, further including a third control configured to cause the predetermined range to be wiped by the wiping section and to cause the washer liquid to be sprayed from the spraying section in a case in which adhesion of extraneous material to the imaging range has been detected based on an image captured by the imaging section. This configuration enables extraneous material in the imaging range to be washed in a short time after adhering in comparison to cases in which wiping by the wiping section and spraying of washer liquid from the spraying section is performed at predetermined intervals.

A tenth aspect of the present disclosure is the ninth aspect of the present disclosure, wherein the third control section causes a range that is narrower than the predetermined range and includes the imaging range and the spray region to be wiped by the wiping section in a case in which adhesion of extraneous material to the imaging range has been detected. This configuration enables the imaging range of the imaging section to be washed while extending the lifespan of the wiping section.

A vehicle washing device according to an eleventh aspect of the present disclosure includes an imaging section disposed inside a vehicle cabin of a vehicle so as to image an exterior of the vehicle cabin through a windshield of the vehicle, a wiping section configured to wipe a predetermined range of the windshield including an imaging range of the imaging section, and a spraying section provided at outside the vehicle cabin so as to spray washer liquid onto the windshield. The spraying section has a spray direction set such that for a spray region of the washer liquid configured by a region interposed between a pair of tangents each extending from the spraying section and tangential to a landing region where the washer liquid sprayed from the spraying section lands on the windshield, any overlap between the spray region and the imaging range is no greater than a predetermined proportion of the imaging range, or the spray region and the imaging range are separated from one another.

Thus, when spraying the washer liquid in order to wash the windshield including the imaging range of the imaging section, a portion of captured images where distortion might appear accompanying this spraying of washer liquid is suppressed to no greater than the predetermined proportion of the imaging range of the imaging section, or to a region excluding the predetermined region of the imaging range. Such a configuration is thereby capable of suppressing distortion from appearing in images captured through the windshield by the imaging section when spraying the washer liquid in order to wash the windshield.

### BRIEF DESCRIPTION OF DRAWINGS

FIG. 1 is a face-on view illustrating a rear section of a vehicle.

FIG. 2 is a plan view illustrating an example of a positional relationship between a spray region of washer liquid from a nozzle of a rear washer and an imaging range of a rear camera.

FIG. 3 is a plan view illustrating an example of a positional relationship between a landing region of washer liquid from a nozzle of a rear washer and a movement range of a portion of a wiper blade that wipes an imaging range of a rear camera.

FIG. 4 is a block diagram schematically illustrating configuration of a control system.

FIG. 5 is a timing chart illustrating an example of wiper speeds of a rear wiper when a wiper switch has been operated.

FIG. 6 is a flowchart illustrating an example of rear windshield cleaning processing.

FIG. 7 is a timing chart illustrating an example of wiping speeds of a rear wiper and spray timings of washer liquid during rear windshield cleaning processing.

FIG. 8 is a plan view illustrating another example of a positional relationship between a spray region of washer liquid from a nozzle of a rear washer and an imaging range of a rear camera.

FIG. 9 is a plan view illustrating another example of a positional relationship between a spray region of washer liquid from a nozzle of a rear washer and an imaging range of a rear camera.

FIG. 10 is a plan view illustrating an example of a predetermined region of an imaging range of a rear camera excluded from overlapping with a washer liquid spray region.

FIG. 11 is a plan view illustrating another example of a predetermined region of an imaging range of a rear camera excluded from overlapping with a washer liquid spray region.

### DESCRIPTION OF EMBODIMENTS

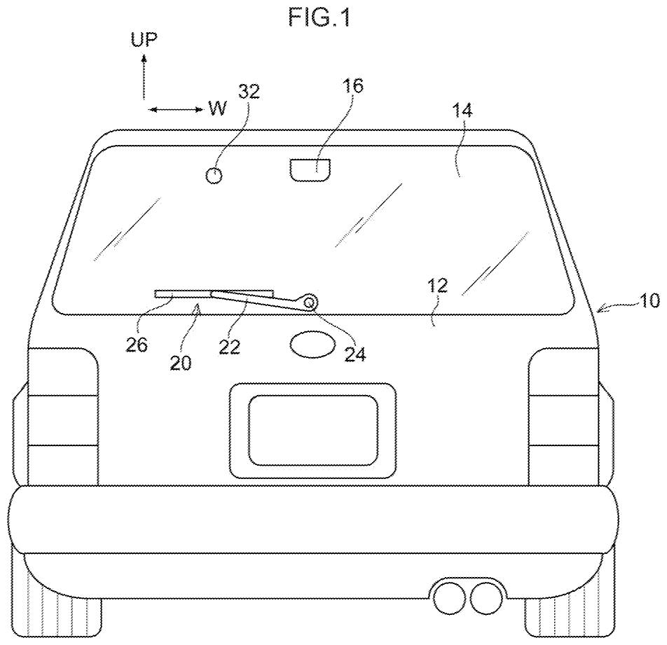

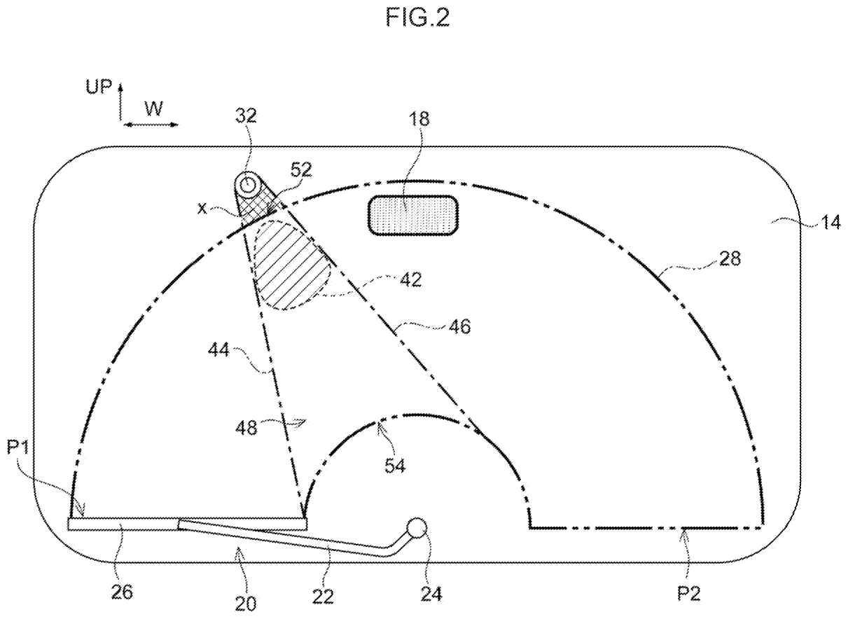

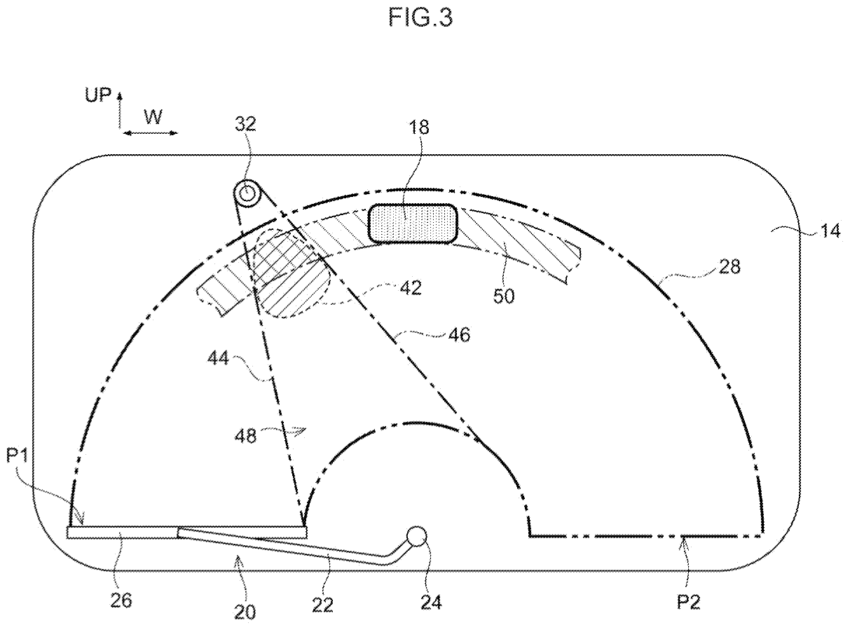

Detailed explanation follows regarding an example of an exemplary embodiment of the present disclosure, with reference to the drawings. As illustrated in FIG. 1, a rear windshield glass 14 serving as an example of a windshield is attached to a back door 12 of a vehicle 10. A rear camera 16 that images an exterior of the vehicle 10, for example the outward, through the rear windshield glass 14 is provided at a vehicle cabin inside of the rear windshield glass 14 in the vicinity of a vehicle width direction central portion that is in the vicinity of a vehicle up-down direction upper end of the rear windshield glass 14 of the back door 12. As illustrated in FIG. 2 and FIG. 3, the rear camera 16 images an imaging range 18 on the rear windshield glass 14. Note that the imaging range 18 corresponds to a display range displayed on a display section 62, described later.

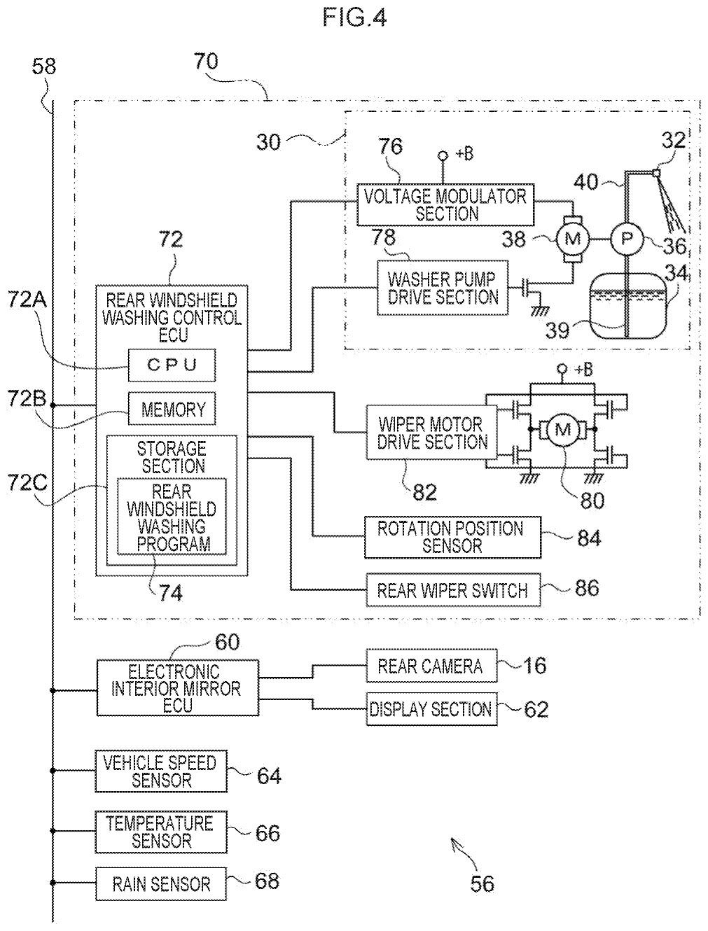

As illustrated in FIG. 4, the rear camera 16 configures an electronic interior mirror together with an electronic interior mirror electronic control unit (ECU; a control unit including a CPU, memory, and a non-volatile storage section) 60 and the display section 62 disposed for example above the vicinity of a vehicle width direction central portion of an instrument panel of the vehicle 10. The rear camera 16 and the display section 62 are connected to the electronic interior mirror ECU 60, and the electronic interior mirror ECU 60 displays images (moving images) captured by the rear camera 16 on the display section 62. Note that the rear camera 16 is an example of an imaging section.

A rear wiper 20 is provided in the vicinity of a vehicle up-down direction lower end of the rear windshield glass 14. The rear wiper 20 includes a wiper arm 22 and a wiper blade 26. A base end portion of the wiper arm 22 is fixed to a pivot shaft 24 disposed in the vicinity of the vehicle up-down direction lower end and also in the vicinity of a vehicle width direction central portion of the rear windshield glass 14. The wiper blade 26 is coupled to a leading end portion of the wiper arm 22. The rear wiper 20 is actuated by drive force of a wiper motor 80 illustrated in FIG. 4, such that the wiper arm 22 swings about the pivot shaft 24 when the drive force of the wiper motor 80 is slowed by a non-illustrated speed reduction mechanism and transmitted to the rear wiper 20.

The wiper blade 26 of the rear wiper 20 thus wipes the rear windshield glass 14 with a to and fro movement across the rear windshield glass 14. As illustrated in FIG. 2 and FIG. 3, the rear wiper 20 wipes a wiping range 28 of the rear windshield glass 14. As can be seen from the wiping range 28 illustrated in FIG. 2 and FIG. 3, in the present exemplary embodiment, the wiper arm 22 has a comparatively wide swing angle, covering 180°. The wiping range 28 includes a stowed position P1 of the wiper blade 26 and a return position P2 of the wiper blade 26. Note that the rear wiper 20 is an example of a wiping section.

A nozzle 32, serving as an example of a spraying section, is provided to a rear washer 30 (see FIG. 4) at a position in the vicinity of the vehicle up-down direction upper end and toward the vehicle width direction left side of the rear windshield glass 14. The nozzle 32 configures the rear washer 30 together with a washer tank 34, a washer pump 36, a motor 38, and hoses 39, 40, each illustrated in FIG. 4. The washer tank 34 holds washer liquid and is provided in an engine compartment of the vehicle 10. One end of the hose 39 is connected to the washer pump 36 configured to supply the washer liquid inside the washer tank 34 to the nozzle 32, and another end of the hose 39 is installed at a bottom portion of the washer tank 34. The hose 40 provides a connection between the washer pump 36 and the nozzle 32.

The washer liquid sprayed from the nozzle 32 of the rear washer 30 lands on the rear windshield glass 14 in a region 42 illustrated in FIG. 2 and FIG. 3. As illustrated in FIG. 2, a washer liquid spray region 48 of the rear washer 30 is interposed between a pair of tangents 44, 46 each extending from the nozzle 32 and tangential to the landing region 42. A washer liquid spray direction of the nozzle 32 is set such that the washer liquid spray region 48 is set at a separation from the imaging range 18 of the rear camera 16 on the rear windshield glass 14. Such a configuration is capable of suppressing distortion from appearing in images captured through the rear windshield glass 14 by the rear camera 16 when spraying the washer liquid from the nozzle 32 of the rear washer 30 in order to wash the rear windshield glass 14.

As illustrated in FIG. 3, the washer liquid spray direction of the nozzle 32 of the rear washer 30 is set such that at least a portion of the landing region 42 overlaps with a movement range (movement range 50 in FIG. 3) on the rear windshield glass 14 of a portion of the wiper blade 26 that wipes the imaging range 18 of the rear camera 16 on the rear windshield glass 14 (a length direction region of the wiper blade 26 that wipes the imaging range 18 of the rear camera 16). The imaging range 18 of the rear camera 16 can thus be effectively washed accompanying spraying of washer liquid from the nozzle 32 of the rear washer 30 and to and fro movement of the wiper blade 26 of the rear wiper 20.

Moreover, as illustrated in FIG. 2, the washer liquid spray direction of the nozzle 32 of the rear washer 30 is set such that a movement trajectory of a leading end portion of the wiper blade 26 on the rear windshield glass 14 cuts across the washer liquid spray region 48 (at a position 52) and a movement trajectory of a base end portion of the wiper blade 26 on the rear windshield glass 14 likewise cuts across the washer liquid spray region 48 (at a position 54). This enables the washer liquid sprayed from the nozzle 32 of the rear washer 30 to be spread across the entire length of the wiper blade 26 of the rear wiper 20, thereby enabling a predetermined range including the imaging range 18 of the rear camera 16 to be effectively washed accompanying spraying of washer liquid from the nozzle 32 of the rear washer 30 and to and fro movement of the wiper blade 26 of the rear wiper 20.

Although the landing region 42 is set within the wiping range 28 in FIG. 2 and FIG. 3, there is no limitation thereto as long as the landing region 42 is within the spray region 48. For example, the landing region 42 may be partially outside the wiping range (see the region x in FIG. 2).

Next, explanation follows regarding a control system. An onboard system 56 illustrated in FIG. 4 includes a bus 58, and plural ECUs that perform different control and plural sensor units are connected together through the bus 58. Note that only portions of the onboard system 56 that are relevant to the present disclosure are illustrated in FIG. 4. The plural ECUs connected to the bus 58 include the electronic interior mirror ECU 60 and a rear windshield washing control ECU 72. The plural sensor units connected to the bus 58 include a vehicle speed sensor 64 that detects the speed of the vehicle 10, a temperature sensor 66 that detects the external temperature, and a rain sensor 68 that detects raindrops as extraneous material adhering to the windshield glass.

The rear windshield washing control ECU 72 configures part of a vehicle washing device 70. The rear windshield washing control ECU 72 includes a CPU 72A, memory 72B, and a non-volatile storage section 72C. The storage section 72C is stored with a rear windshield washing program 74. The rear windshield washing program 74 is read from the storage section 72C and expanded in the memory 72B to be executed by the CPU 72A. The rear windshield washing control ECU 72 thus performs rear windshield cleaning processing, described later. The rear windshield washing control ECU 72 is an example of a first control section, a second control section, and a third control section.

The rear windshield washing control ECU 72 is connected to the motor 38 that drives the washer pump 36 through a voltage modulator section 76 and a washer pump drive section 78. The voltage modulator section 76 supplies the motor 38 with an operating voltage of a magnitude instructed by the rear windshield washing control ECU 72. The washer pump drive section 78 is instructed with an actuation timing and actuation duration of the motor 38 by the rear windshield washing control ECU 72, and switches the motor 38 ON at the instructed actuation timing and for the instructed actuation duration.

The rear windshield washing control ECU 72 is connected to the wiper motor 80 that generates drive force to cause the rear wiper 20 to wipe to and fro through a wiper motor drive section 82. The rear windshield washing control ECU 72 is also connected to a rotation position sensor 84 that detects a rotation speed and rotation angle of an output shaft of the wiper motor 80, and rear wiper switches 86. The wiper motor drive section 82 is instructed of a drive direction and drive speed of the wiper motor 80 by the rear windshield washing control ECU 72, and controls drive of the wiper motor 80 in response to the instructed drive direction and drive speed. The rear wiper switches 86 include a first switch to instruct wiping of the rear windshield glass 14 with the rear wiper 20, and a second switch to instruct spraying of washer liquid from the nozzle 32 of the rear washer 30.

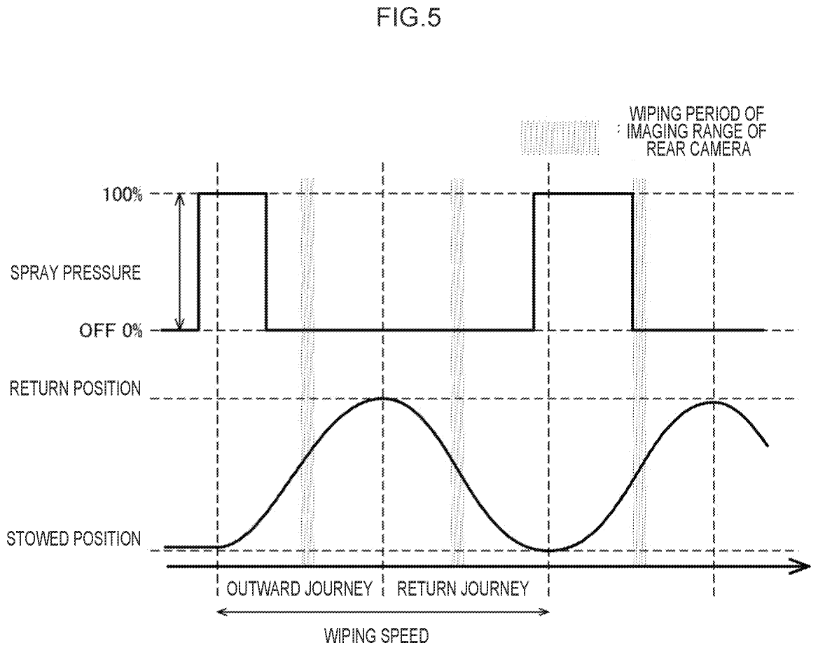

Explanation follows regarding operation of the present exemplary embodiment. In a case in which the first switch of the rear wiper switches 86 is operated by a vehicle occupant to instruct wiping of the rear windshield glass 14 with the rear wiper 20, the rear windshield washing control ECU 72 drives the wiper motor 80 with the wiper motor drive section 82 such that for example, the wiping speed of the rear windshield glass 14 by the rear wiper 20 changes to the sine wave pattern illustrated in FIG. 5. In such cases, no particular control is performed with respect to the wiping speed at which the rear wiper 20 wipes the imaging range 18 of the rear camera 16.

In a case in which the second switch of the rear wiper switches 86 is operated by a vehicle occupant to instruct spraying of the washer liquid from the nozzle 32 of the rear washer 30, the rear windshield washing control ECU 72 drives the motor 38 (washer pump 36) using the voltage modulator section 76 and the washer pump drive section 78 so as to spray washer liquid from the nozzle 32 at the 100% spray pressure illustrated in FIG. 5 for example while the second switch is being operated. When this is performed, no particular control is performed with respect to the spray timing or spray pressure of the washer liquid from the nozzle 32 of the rear washer 30.

Note that although FIG. 5 illustrates a case in which the first switch is operated to instruct wiping by the rear wiper 20 and the second switch is further operated to instruct spraying of washer liquid from the nozzle 32 of the rear washer 30, configuration may be made such that the rear windshield glass 14 is wiped by the rear wiper 20 in coordination with spraying of washer liquid from the nozzle 32 when the second switch is operated.

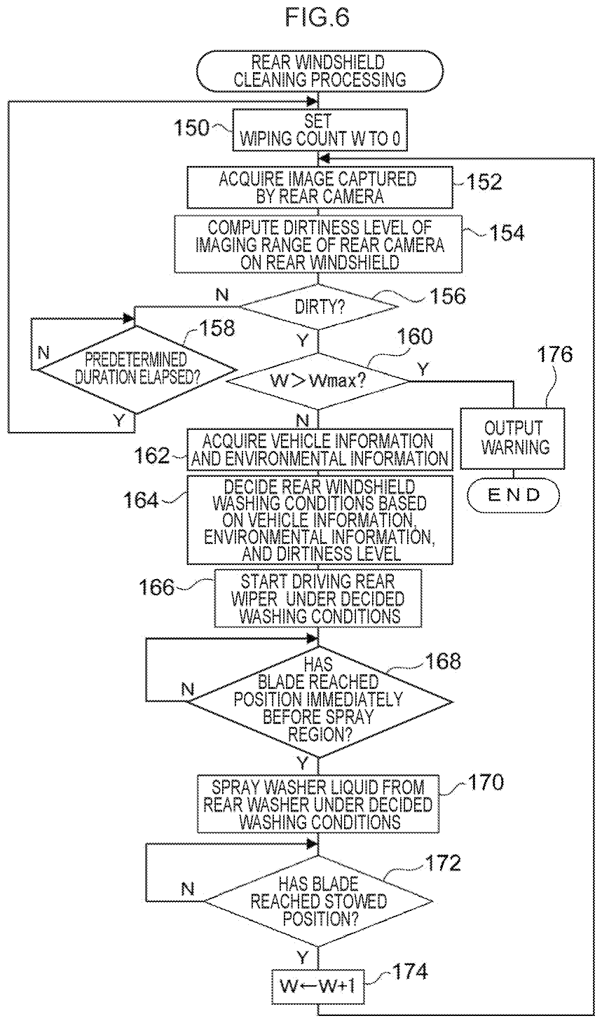

The rear windshield washing control ECU 72 also performs the rear windshield cleaning processing illustrated in FIG. 6 while an ignition switch of the vehicle 10 is at an ON position. At step 150 of the rear windshield cleaning processing, the rear windshield washing control ECU 72 sets the count value W of a counter that counts the number of wipes to zero. At step 152, the rear windshield washing control ECU 72 acquires an image of the vehicle 10 outside captured by the rear camera 16 from the electronic interior mirror ECU 60.

At step 154, the rear windshield washing control ECU 72 computes an evaluation value for evaluating a dirtiness level of the imaging range 18 of the rear camera 16 on the rear windshield glass 14 based on the image acquired at step 152. An evaluation value for evaluating the overall dirtiness level (transmissivity) of the imaging range 18 may be applied as an example of the dirtiness level evaluation value of the imaging range 18. As a specific example, a value obtained by standardizing an average brightness or minimum brightness of the overall image using a numerical range of 0 to 100 may be applied as the dirtiness level evaluation value of a washing target. At step 156, the rear windshield washing control ECU 72 compares the dirtiness level evaluation value of the imaging range 18 computed at step 154 against a predetermined value to determine whether or not the imaging range 18 is dirty.

In a case in which the dirtiness level evaluation value of the imaging range 18 is the predetermined value or greater (the dirtiness level is low), determination is negative at step 156 and processing transitions to step 158. At step 158, the rear windshield washing control ECU 72 determines whether or not a predetermined duration has elapsed since the previous determination that the imaging range 18 is not dirty was made, and step 158 is repeated until determination becomes affirmative. Note that the predetermined duration may be several minutes or several tens of minutes, and the length of the predetermined duration may be varied according to the weather conditions. In a case in which determination is affirmative at step 158, processing returns to step 150. In this manner, in a case in which the dirtiness level of the imaging range 18 has been determined to be low, a check as to whether or not the dirtiness level of the imaging range 18 remains low is performed at intervals of the predetermined duration.

In a case in which the dirtiness level evaluation value of the imaging range 18 is less than the predetermined value (the dirtiness level is high), determination is affirmative at step 156 and processing transitions to step 160. At step 160, the rear windshield washing control ECU 72 determines whether or not the wiping count value W has exceeded a predetermined upper limit value Wmax. In a case in which determination is negative at step 160, processing transitions to step 162. At step 162, the rear windshield washing control ECU 72 acquires vehicle information and environmental information. In this example, the speed of the vehicle 10 is acquired from the vehicle speed sensor 64 as an example of the vehicle information, and the temperature and weather conditions around the vehicle 10 are acquired from the temperature sensor 66 and the rain sensor 68 as an example of the environmental information. However, there is no limitation thereto.

At step 164, the rear windshield washing control ECU 72 decides washing conditions of the rear windshield glass 14 based on the vehicle information and environmental information acquired at step 162 and the dirtiness level of the imaging range 18 computed at step 154. The washing conditions include the wiping speed with which the wiper blade 26 of the rear wiper 20 wipes the imaging range 18 of the rear camera 16 (referred to hereafter simply as the “wiping speed”), and the spray pressure of the washer liquid from the nozzle 32 of the rear washer 30 (referred to hereafter simply as the “spray pressure”). Note that the spray pressure changes according to the voltage supplied to the motor 38.

Under the washing conditions, a washing level is raised by lowering the wiping speed, and the washing level is also raised by increasing the spray pressure. The rear windshield washing control ECU 72 decides the washing conditions such that for example the washing level is raised as the dirtiness level of the imaging range 18 of the rear camera 16 increases, such that the washing level is raised as the vehicle speed increases, such that the washing level is raised as the temperature drops, and such that the washing level is raised more in snowy weather conditions than in other weather conditions. Note that detection as to whether or not the weather conditions are snowy may for example be implemented by combining a raindrop detection result of the rain sensor 68 with a temperature detection result of the temperature sensor 66.

At step 166, the rear windshield washing control ECU 72 uses the wiper motor drive section 82 to control drive of the wiper motor 80 so as to start movement of the wiper blade 26 of the rear wiper 20 under the washing conditions decided at step 164. At step 168, the rear windshield washing control ECU 72 determines whether or not the wiper blade 26 has reached a position corresponding to a position immediately before the washer liquid spray region 48 of the nozzle 32 of the rear washer 30. In a case in which determination is negative at step 168, step 168 is repeated until determination becomes affirmative. When this is being performed, the control to drive the wiper motor 80 is continued such that the wiper blade 26 moves under the washing conditions decided at step 164.

When the wiper blade 26 reaches the position corresponding to the position immediately before (within a predetermined distance of) the washer liquid spray region 48, determination is affirmative at step 168 and processing transitions to step 170. At step 170, the rear windshield washing control ECU 72 uses the voltage modulator section 76 and the washer pump drive section 78 to control drive of the motor 38 such that washer liquid is sprayed from the nozzle 32 of the rear washer 30 under the washing conditions decided at step 164.

The washer liquid sprayed from the nozzle 32 of the rear washer 30 is thus promptly supplied to the wiper blade 26 that has moved as far as the washer liquid spray region 48, and spreads over the entire length of the wiper blade 26. The wiper blade 26 then reaches the imaging range 18 of the rear camera 16 and wipes the imaging range 18 of the rear camera 16, thereby washing the imaging range 18 of the rear camera 16.

At the next step 172, the rear windshield washing control ECU 72 determines whether or not the wiper blade 26 has reached the stowed position P1. In a case in which the wiper blade 26 has not yet reached the stowed position P1, determination is negative and step 172 is repeated. When the wiper blade 26 reaches the stowed position P1, determination is affirmative at step 172, and processing transitions to step 174. At step 174, the rear windshield washing control ECU 72 increments the wiping count value W by one, and processing returns to step 152.

Washing of the imaging range 18 of the rear camera 16 by wiping with the rear wiper 20 and spraying the washer liquid from the nozzle 32 of the rear washer 30 is thus repeated while the imaging range 18 is dirty (determination is affirmative at step 156) and the wiping count value W is the upper limit value Wmax or lower (determination is negative at step 160).

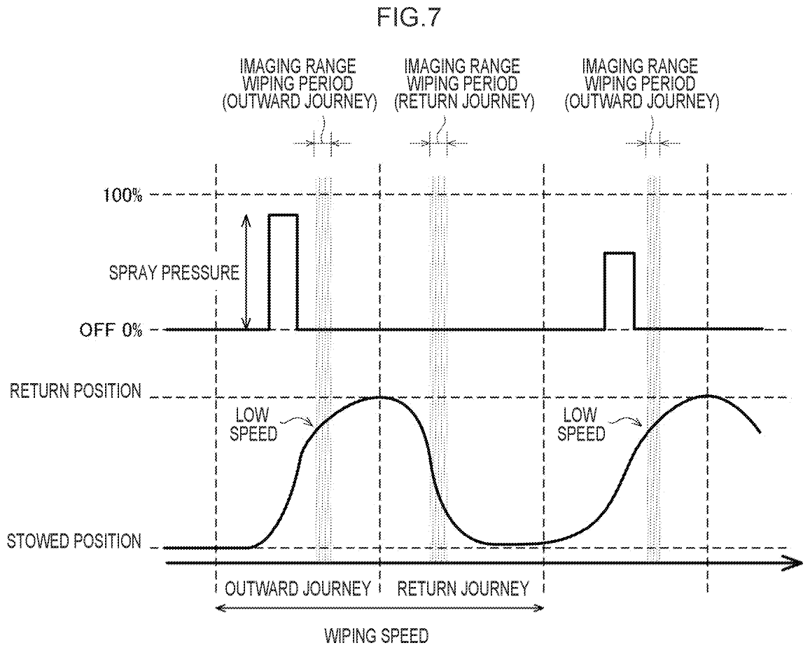

Further explanation follows regarding this wiping by the rear wiper 20 and spraying of the washer liquid from the rear washer 30, with reference to the example illustrated in FIG. 7. As illustrated in FIG. 7, spraying of the washer liquid from the rear washer 30 is only performed when the washer liquid spray region 48 and the imaging range 18 of the rear camera 16 are positioned in this sequence on a movement direction downstream side of the wiper blade 26, namely when the rear wiper 20 is wiping on an outward journey (the washer liquid is not sprayed on a return journey). The rear windshield washing control ECU 72 only slows the wiping speed at the imaging range 18 of the rear camera 16 on the outward wiping journey of the rear wiper 20, as labeled “low speed” in FIG. 7. This enables the imaging range 18 of the rear camera 16 to be effectively washed. For example, in cold climate regions or low temperature environments, in a case in which material such as frost, road anti-freezing agents (salt or the like), or mud has adhered to the rear windshield surface, setting the wiping speed to “low speed” enables such frost to be scraped off.

FIG. 7 illustrates a case in which a first wipe of the rear wiper 20 has reduced the dirtiness level of the imaging range 18 of the rear camera 16, and the spray pressure is decreased the second time the washer liquid is sprayed from the rear washer 30 in comparison to the first time the washer liquid is sprayed from the rear washer 30. Changing the washing conditions such as the washer liquid spray pressure according to the dirtiness level of the imaging range 18 of the rear camera 16 and so on in this manner enables greater washer liquid consumption than required to be suppressed.

On the other hand, in a case in which the imaging range 18 is still dirty even after the wiping count value W has exceeded the upper limit value Wmax, determination is affirmative at step 160 and processing transitions to step 176. At step 176, the rear windshield washing control ECU 72 notifies the occupant of the vehicle 10 that it is difficult to remove the dirt on the imaging range 18 using the rear wiper 20 and the rear washer 30, for example by illuminating a warning lamp or outputting an audio warning message. The rear windshield cleaning processing is then ended. In such cases, the occupant is to perform a task to wipe off the dirt from the imaging range 18 using a rag or the like.

Note that in the exemplary embodiment described above, as illustrated in FIG. 7, the rear windshield washing control ECU 72 only sets the wiping speed at the imaging range 18 of the rear camera 16 to a high speed on the return wiping journey of the rear wiper 20. This enables the duration for which the imaging range 18 and the rear wiper 20 overlap (the duration in which the rear wiper 20 appears in the display section 62) to be shortened.

Although explanation has been given regarding a mode in which washer liquid is only sprayed on the outward wiping journey of the rear wiper 20 in the exemplary embodiment described above, there is no limitation thereto, and washer liquid may also be sprayed on the return wiping journey of the rear wiper 20.

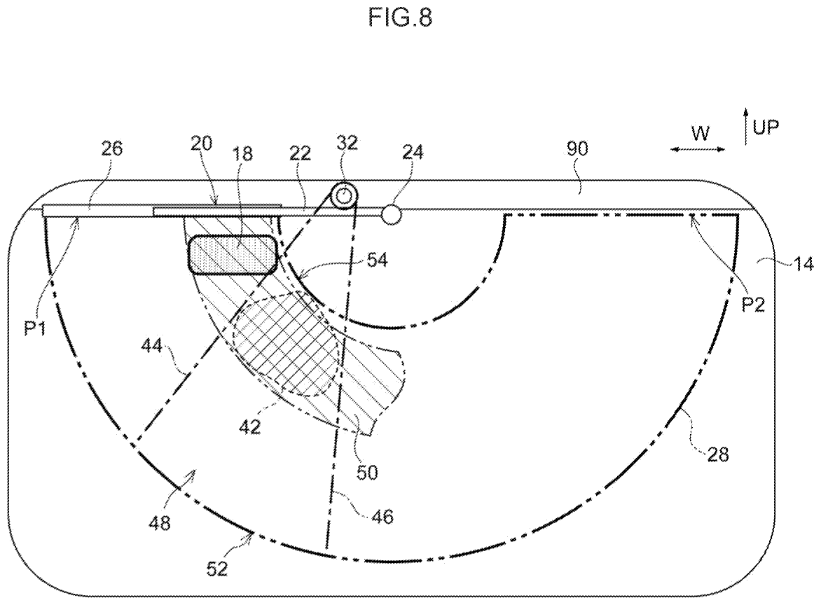

Although explanation has been given regarding a mode in which the pivot shaft 24 of the rear wiper 20 is disposed in the vicinity of the vehicle up-down direction lower end and in the vicinity of the vehicle width direction central portion of the rear windshield glass 14, there is no limitation thereto. As an example, FIG. 8 illustrates a mode in which the pivot shaft 24 of the rear wiper 20 is disposed in the vicinity of the vehicle up-down direction upper end and in the vicinity of the vehicle width direction central portion of the rear windshield glass 14. In the example illustrated in FIG. 8, the rear camera 16 is disposed toward the vehicle width direction left side, and the nozzle 32 of the rear washer 30 is provided to a rear spoiler 90 attached to the vehicle up-down direction upper end of the rear windshield glass 14 such that the vehicle width direction position of the nozzle 32 corresponds to a position between the pivot shaft 24 and the rear camera 16.

In FIG. 8, washer liquid sprayed from the nozzle 32 of the rear washer 30 lands in the landing region 42 on the rear windshield glass 14. Again, in the example illustrated in FIG. 8, the washer liquid spray direction of the nozzle 32 of the rear washer 30 is set such that the washer liquid spray region 48 interposed between the pair of tangents 44, 46 each extending from the nozzle 32 and tangential to the landing region 42 is at a separation from the imaging range 18 of the rear camera 16 on the rear windshield glass 14. Such a configuration is capable of suppressing distortion from appearing in images captured through the rear windshield glass 14 by the rear camera 16 when spraying the washer liquid from the nozzle 32 of the rear washer 30 in order to wash the rear windshield glass 14.

Moreover, in the example illustrated in FIG. 8, the washer liquid spray direction of the nozzle 32 of the rear washer 30 is set such that at least a portion of the landing region 42 overlaps with the movement range 50 on the rear windshield glass 14 of a portion of the wiper blade 26 that wipes the imaging range 18 of the rear camera 16 on the rear windshield glass 14. The imaging range 18 of the rear camera 16 can thus be effectively washed accompanying spraying of washer liquid from the nozzle 32 of the rear washer 30 and to and fro movement of the wiper blade 26 of the rear wiper 20.

Moreover, in the example illustrated in FIG. 8, the washer liquid spray direction of the nozzle 32 of the rear washer 30 is set such that a movement trajectory of the leading end portion of the wiper blade 26 on the rear windshield glass 14 cuts across the washer liquid spray region 48 at the position 52 and a movement trajectory of the base end portion of the wiper blade 26 on the rear windshield glass 14 likewise cuts across the washer liquid spray region 48 at the position 54. This enables the washer liquid sprayed from the nozzle 32 of the rear washer 30 to be spread across the entire length of the wiper blade 26 of the rear wiper 20, thereby enabling a predetermined range including the imaging range 18 of the rear camera 16 to be effectively washed accompanying spraying of washer liquid from the nozzle 32 of the rear washer 30 and to and fro movement of the wiper blade 26 of the rear wiper 20.

Moreover, in the configuration illustrated in FIG. 8, the landing region 42 on the rear windshield glass 14 is positioned further to the movement direction downstream side than the imaging range 18 of the rear camera 16 during outward movement of the wiper blade 26. Accordingly, when washing the imaging range 18 of the rear camera 16, the rear windshield washing control ECU 72 controls drive of the wiper motor 80 such that the wiper blade 26 first performs an outward movement to a position past the landing region 42 on the rear windshield glass 14 (a position further downstream than the tangent 46). Next, the rear windshield washing control ECU 72 controls drive of the wiper motor 80 such that the wiper blade 26 performs a return movement to the stowed position P1, and also controls drive of the wiper motor 38 such that washer liquid is sprayed from the nozzle 32 of the rear washer 30. The wiper blade 26 accordingly wipes the imaging range 18 of the rear camera 16 in a state in which the washer liquid sprayed from the nozzle 32 has been supplied thereto, thus enabling the imaging range 18 of the rear camera 16 to be effectively washed. The above control is an example of control causing “a range that is narrower than the predetermined range to be wiped by the wiping section”. This narrower range refers to a range with a smaller angle or a range with a smaller area. Note that in the configuration illustrated in FIG. 8, washer liquid may also be sprayed from the nozzle 32 of the rear washer 30 during outward movement of the wiper blade 26.

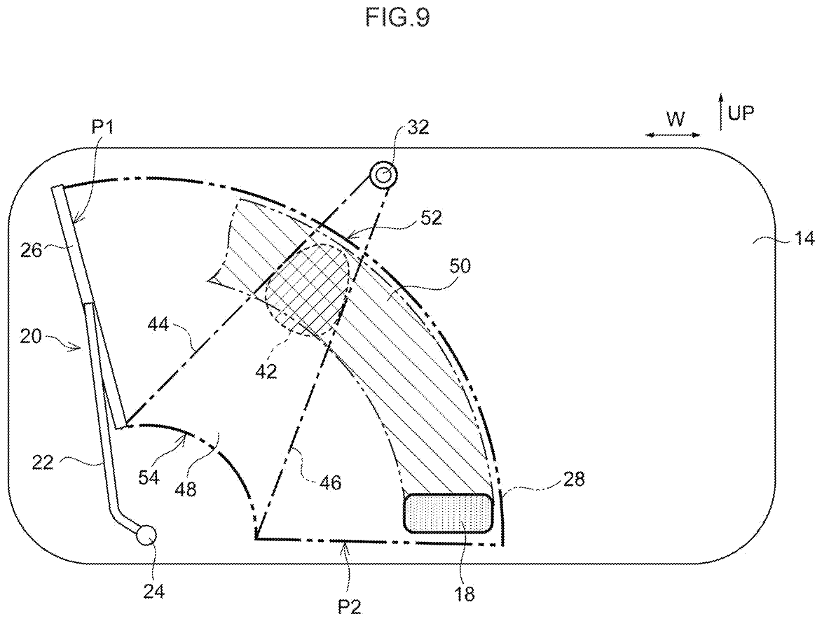

Although explanation has been given regarding a mode in which the imaging range 18 of the rear camera 16 is positioned in the vicinity of the vehicle up-down direction upper end of the rear windshield glass 14, and the wiper arm 22 has a comparatively wide swing angle of approximately 180°, there is no limitation thereto. FIG. 9 illustrates an example in which the imaging range 18 of the rear camera 16 is positioned in the vicinity of the vehicle up-down direction lower end of the rear windshield glass 14, and the wiper arm 22 has a comparatively narrow swing angle of approximately 100°. In the example in FIG. 9, the pivot shaft 24 of the rear wiper 20 is disposed in the vicinity of the vehicle up-down direction lower end and toward the vehicle width direction left side of the rear windshield glass 14, and the nozzle 32 of the rear washer 30 is disposed at a position in the vicinity of the vehicle width direction central portion and in the vicinity of the vehicle up-down direction upper end of the rear windshield glass 14.

In FIG. 9, the washer liquid sprayed from the nozzle 32 of the rear washer 30 lands in the landing region 42 on the rear windshield glass 14. In the example illustrated in FIG. 9, the washer liquid spray direction of the nozzle 32 of the rear washer 30 is set such that the washer liquid spray region 48 interposed between the pair of tangents 44, 46 each extending from the nozzle 32 and tangential to the landing region 42 is at a separation from the imaging range 18 of the rear camera 16 on the rear windshield glass 14. Such a configuration is capable of suppressing distortion from appearing in images captured through the rear windshield glass 14 by the rear camera 16 when spraying the washer liquid from the nozzle 32 of the rear washer 30 in order to wash the rear windshield glass 14.

Moreover, in the example illustrated in FIG. 9, the washer liquid spray direction of the nozzle 32 of the rear washer 30 is set such that at least a portion of the landing region 42 overlaps with the movement range 50 on the rear windshield glass 14 of a portion of the wiper blade 26 that wipes the imaging range 18 of the rear camera 16 on the rear windshield glass 14. The imaging range 18 of the rear camera 16 can thus be effectively washed accompanying spraying of washer liquid from the nozzle 32 of the rear washer 30 and to and fro movement of the wiper blade 26 of the rear wiper 20.

Moreover, in the example illustrated in FIG. 9, the washer liquid spray direction of the nozzle 32 of the rear washer 30 is set such that a movement trajectory of the leading end portion of the wiper blade 26 on the rear windshield glass 14 cuts across the washer liquid spray region 48 at the position 52 and a movement trajectory of the base end portion of the wiper blade 26 on the rear windshield glass 14 likewise cuts across the washer liquid spray region 48 at the position 54. This enables the washer liquid sprayed from the nozzle 32 of the rear washer 30 to be spread across the entire length of the wiper blade 26 of the rear wiper 20, thereby enabling a predetermined range including the imaging range 18 of the rear camera 16 to be effectively washed accompanying spraying of washer liquid from the nozzle 32 of the rear washer 30 and to and fro movement of the wiper blade 26 of the rear wiper 20.

Although explanation has been given regarding a mode in which the washer liquid spray direction of the nozzle 32 of the rear washer 30 is set such that the washer liquid spray region 48 of the nozzle 32 is at a separation from the imaging range 18 of the rear camera 16 on the rear windshield glass 14, there is no limitation thereto. As long as the overlap between the washer liquid spray region 48 of the nozzle 32 and the imaging range 18 of the rear camera 16 is no greater than a predetermined proportion of the imaging range 18, for example no greater than 20% thereof, a range in which distortion might appear in images captured through the rear windshield glass 14 by the rear camera 16 can be suppressed to a small size, enabling the images captured by the rear camera 16 to be utilized for their intended purpose, such as an electronic interior mirror, without issue.

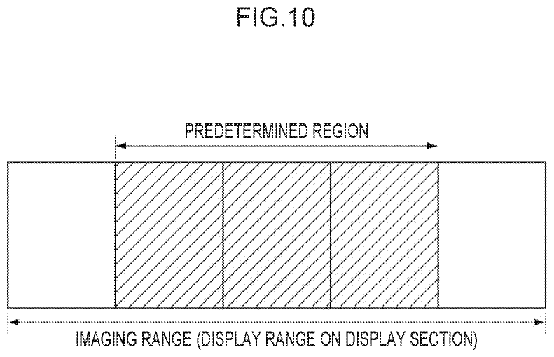

Moreover, in a case in which an overlap between the washer liquid spray region 48 and the imaging range 18 of the rear camera 16 is permitted, if the imaging range 18 is divided into five equal segments in the vehicle width direction as illustrated in the example in FIG. 10, the washer liquid spray direction of the nozzle 32 is preferably set such that the washer liquid spray region 48 is at a separation from a predetermined region of the imaging range 18 (the region indicated by diagonal lines) that excludes regions at both vehicle width direction ends of the imaging range 18. Such a configuration suppresses washer liquid from being sprayed in and around a vehicle width direction central portion of the imaging range 18, this being an important region (a region where relevant objects such as vehicles present outside the vehicle are most likely to be positioned). This thereby enables the impact on images captured by the rear camera 16 to be suppressed to a low level, even if the washer liquid spray region 48 and the imaging range 18 overlap each other.

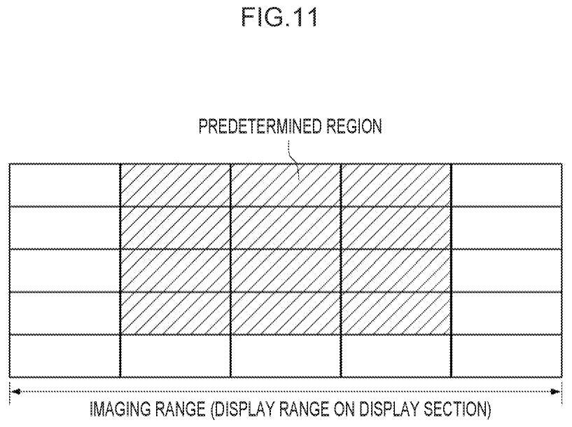

Furthermore, as illustrated in the example in FIG. 11, it is even more preferable to set a region of the imaging range 18 (the region indicated by diagonal lines) as the predetermined region described above so as to exclude a lower end region when the imaging range 18 is divided into five equal segments in the vehicle up-down direction. A region in the vicinity of the lower end of the imaging range 18 corresponds to a region of lower importance in the captured images, and the impact is low even if washer liquid drips downward from this region. This thereby enables the impact on images captured by the rear camera 16 to be suppressed to an even lower level, even if the washer liquid spray region 48 and the imaging range 18 overlap each other.

The disclosure of Japanese Patent Application No. 2018-111978, filed on Jun. 12, 2018, is incorporated in its entirety by reference herein. All cited documents, patent applications, and technical standards mentioned in the present specification are incorporated by reference in the present specification to the same extent as if each individual cited document, patent application, or technical standard was specifically and individually indicated to be incorporated by reference.

1. A vehicle washing device, comprising:
a wiping section configured to wipe a predetermined range on a windshield of a vehicle, the predetermined range including an imaging range of an imaging section configured to image an exterior of the vehicle through the windshield from inside a vehicle cabin; and
a spraying section provided outside the vehicle cabin and configured to spray a washer liquid onto the windshield,
the spraying section having a spray direction of the washer liquid configured such that a spray region of the washer liquid interposed between a pair of tangents, each extending from the spraying section and tangential to a landing region at which the sprayed washer liquid lands on the windshield, has an overlap with the imaging range of no greater than a predetermined proportion of the imaging range, or such that the spray region is separated from a predetermined region of the imaging range.

2. The vehicle washing device of claim 1, wherein the predetermined region is a region excluding regions at respective ends of the imaging range in a width direction of the vehicle when the imaging range is divided into five equal segments in the width direction.

3. The vehicle washing device of claim 2, wherein the predetermined region is a region excluding a lower end region when the imaging range is divided into five equal segments in a vertical direction of the vehicle.

4. The vehicle washing device of claim 1, wherein:
the wiping section wipes the predetermined range by moving a wiper blade to and fro; and
in the spraying section, the washer liquid spray direction is configured such that at least a portion of the landing region of the washer liquid overlaps with a movement range on the windshield of a portion of the wiper blade that wipes the imaging range.

5. The vehicle washing device of claim 1, wherein:
the wiping section wipes the predetermined range by moving a wiper blade to and fro; and
in the spraying section, the washer liquid spray direction is configured such that a movement trajectory of one end portion of the wiper blade on the windshield cuts across the washer liquid spray region and a movement trajectory of another end portion of the wiper blade on the windshield cuts across the washer liquid spray region.

6. The vehicle washing device of claim 1, wherein, in the spraying section, the washer liquid spray direction is configured such that any overlap between the washer liquid spray region and the imaging range is no greater than 20% of the imaging range.

7. The vehicle washing device of claim 1, wherein:
the wiping section wipes the predetermined range by moving a wiper blade to and fro; and
the vehicle washing device further comprises a first control section configured to cause the washer liquid to be sprayed from the spraying section, in a state in which the spray region and the imaging range are positioned in this sequence on a movement direction downstream side during an outward movement or during a return movement of the wiper blade, and the wiper blade has approached to within a predetermined distance of the spray region.

8. The vehicle washing device of claim 1, wherein:
the wiping section wipes the predetermined range by moving a wiper blade to and fro; and
the vehicle washing device further comprises a second control section that controls a movement speed of the wiper blade, as the wiper blade wipes the imaging range when the washer liquid is being sprayed from the spraying section, so as to be slower than a movement speed of the wiper blade when the washer liquid is not being sprayed from the spraying section.

9. The vehicle washing device of claim 1, further comprising a third control section configured to cause the predetermined range to be wiped by the wiping section and to cause the washer liquid to be sprayed in a case in which adhesion of extraneous material to the imaging range has been detected based on an image captured by the imaging section.

10. The vehicle washing device of claim 9, wherein the third control section causes a range that is narrower than the predetermined range and that includes the imaging range and the spray region to be wiped by the wiping section in a case in which adhesion of extraneous material to the imaging range has been detected.

11. A vehicle washing device, comprising:
an imaging section disposed inside a vehicle cabin of a vehicle so as to image an exterior of the vehicle cabin through a windshield of the vehicle;
a wiping section configured to wipe a predetermined range of the windshield, the predetermined range including an imaging range of the imaging section; and
a spraying section provided outside the vehicle cabin and configured to spray a washer liquid onto the windshield,
the spraying section having a spray direction of the spraying section configured such that, for a spray region of the washer liquid configured by a region interposed between a pair of tangents, each extending from the spraying section and tangential to a landing region at which the washer liquid sprayed from the spraying section lands on the windshield, any overlap between the spray region and the imaging range is no greater than a predetermined proportion of the imaging range, or the spray region and the imaging range are separated from one another.
